(19) United States
(12) Patent Application Publication
(10) Pub. No.: US 2023/0098392 A1
(43) Pub. Date: Mar. 30, 2023

(54) ANTENNA DEVICE AND ELECTRONIC APPARATUS

(71) Applicant: Murata Manufacturing Co., Ltd., Nagaokakyo-shi (JP)

(72) Inventors: Takafumi NASU, Nagaokakyo-shi (JP); Kenichi ISHIZUKA, Nagaokakyo-shi (JP)

(21) Appl. No.: 18/075,457

(22) Filed: Dec. 6, 2022

Related U.S. Application Data
(63) Continuation of application No. PCT/JP2021/016933, filed on Apr. 28, 2021.

(30) Foreign Application Priority Data
Jul. 3, 2020 (JP) 2020-115469

(51) Int. Cl. H01Q 9/28; H01Q 1/52

(52) U.S. Cl. CPC H01Q 9/285; H01Q 1/526

(57) ABSTRACT

An antenna device includes a circuit substrate, first and second radiators each including an open end, and a coupler to electromagnetically couple the first and second radiators, the antenna device being provided in a housing of an electronic apparatus. Shield cases each including a planar conductor portion parallel or substantially parallel to a first main surface are mounted on the circuit substrate, the first radiator, the second radiator, and the shield cases are located on a side of the first main surface of the circuit substrate, and the first radiator includes a portion overlapping a first region between the multiple shield cases in plan view of the circuit substrate.

### CROSS REFERENCE TO RELATED APPLICATIONS

This application claims the benefit of priority to Japanese Patent Application No. 2020-115469 filed on Jul. 3, 2020 and is a Continuation Application of PCT Application No. PCT/JP2021/016933 filed on Apr. 28, 2021. The entire contents of each application are hereby incorporated herein by reference.

### BACKGROUND OF THE INVENTION

### 1. Field of the Invention

The present invention relates to an antenna device connected to a radio frequency circuit and an electronic apparatus including the antenna device.

### 2. Description of the Related Art

A known antenna device for communication provided in a small-sized electronic apparatus includes a radiator disposed on a region (GND-free area) where no ground conductor is provided on a circuit substrate, as disclosed in U.S. Patent Application Publication No. 2014/0306857, for example. With the configuration described above, the radiator is not affected by the ground conductor and maintains the intrinsic characteristics of the radiator.

For example, in a smartphone and the like supporting a fifth generation mobile communication system (5G), an antenna device covering a broad bandwidth is required with the expansion of a frequency band used. The number of radiators to be provided is increased in order to broaden a bandwidth of an antenna device, and this may lead to a case that some of the radiators have to be disposed on a region (GND area) where a ground conductor is provided on a PCB.

However, when a radiator is disposed on a GND area, the following problems occur.

When two radiators are electrically coupled by bringing open ends thereof close to each other, if a ground conductor is present in the vicinity, the electric field coupling between the two radiators is weakened due to an influence of the ground conductor.

When the open ends of the radiators are brought closer to each other in order to eliminate the weakening of the electric field coupling above, the electric fields at the open ends of the two radiators weaken each other in a frequency band in which the electric fields at the open ends of the two radiators have opposite polarities, and thus, radiation efficiency deteriorates.

In the GND area, a shield case electrically connected to a ground electric potential is disposed in some cases in order to shield, for example, a wireless circuit. However, when a design restriction that the open ends of the two radiators are brought close to each other is present, each radiator is not allowed to be disposed at a position, separated from the ground conductor where radiation is easily made, and as a result, the radiation efficiency deteriorates.

Due to adverse effects and restrictions above, it is difficult to provide an electric field coupling type parasitic radiator on a GND area.

### SUMMARY OF THE INVENTION

Preferred embodiments of the present invention provide antenna devices which each ensure coupling between two radiators by reducing an influence of a ground conductor while the two radiators are provided in a region where the ground conductor is provided, and electronic apparatuses each including such antenna devices.

An antenna device according to a preferred embodiment of the present invention includes a circuit substrate including a first main surface and a second main surface opposed to each other, a first radiator including an open end, a second radiator including an open end, a coupler connected to the first radiator and the second radiator and electromagnetically coupling the first radiator and the second radiator, and a connection portion of a feed circuit to the first radiator. The antenna device is provided in a housing of an electronic apparatus. Further, the antenna device includes multiple mounted components provided on the circuit substrate and each including a planar conductor portion parallel or substantially parallel to the first main surface. The first radiator, the second radiator, and the multiple mounted components are located on a side of the first main surface of the circuit substrate, and the first radiator includes a portion overlapping a first region located between the multiple mounted components in plan view of the circuit substrate.

With the configuration described above, since the first radiator and the second radiator are coupled to each other through the coupler, the open ends of the first radiator and the second radiator may be separated from each other. This eliminates unnecessary interference between the first radiator and the second radiator, and the radiation efficiency is increased. Further, since the first radiator includes the portion overlapping the first region located between the multiple mounted components in plan view of the circuit substrate, the first radiator is separated from the mounted component including the planar conductor portion parallel or substantially parallel to the first main surface, and the radiation efficiency thereof is ensured.

An electronic apparatus according to a preferred embodiment of the present invention includes an antenna device according to a preferred embodiment of the present invention, a housing that houses the antenna device, and a feed circuit which feeds power to the antenna device directly or through the coupler.

With the configuration described above, it is possible to obtain electronic apparatuses each having an antenna function over a broad bandwidth while including a circuit substrate and a housing of limited sizes.

According to preferred embodiments of the present invention, it is possible to obtain antenna devices that each ensure coupling between two radiators by relaxing an influence of a ground conductor while the two radiators are in a region where the ground conductor is located, and electronic apparatuses each including such an antenna device.

The above and other elements, features, steps, characteristics and advantages of the present invention will become more apparent from the following detailed description of the preferred embodiments with reference to the attached drawings.

### BRIEF DESCRIPTION OF THE DRAWINGS

FIGS. 1A and 1B are diagrams each illustrating a main portion of an electronic apparatus 201 including an antenna device 101 according to a first preferred embodiment of the present invention.

FIG. 2 is a three-view diagram of a portion corresponding to the antenna device 101.

FIG. 3 is a conceptual graph illustrating a relationship between radiation efficiency and an interval between a radiator and a ground conductor.

FIG. 4 is a circuit diagram of the antenna device 101.

FIG. 5 is a graph illustrating a frequency characteristic of a reflection coefficient of each of antenna devices 101, 111, and 112.

FIG. 6 is a graph illustrating a frequency characteristic of radiation efficiency of each of the antenna devices 101, 111, and 112.

FIGS. 7A and 7B are diagrams each illustrating a polarity relationship between open ends of a first radiator 10 and a second radiator 20 in a predetermined frequency band in the antenna device 101.

FIG. 8 is a graph illustrating frequency characteristics of radiation efficiency of the antenna device 101 and the antenna device 112.

FIG. 9A is a diagram illustrating an operation of the antenna device 101 under a specific condition, and FIG. 9B is a diagram illustrating an operation of the antenna device 112 under a specific condition.

FIG. 10 is an external perspective view of a coupler 30 and an exploded perspective view thereof.

FIGS. 11A and 11B are each a circuit diagrams of an antenna device 102 according to a second preferred embodiment of the present invention.

FIG. 12 is a graph illustrating a frequency characteristic of a reflection coefficient of the antenna device 102.

FIG. 13 is a circuit diagram of an antenna device 103 according to a third preferred embodiment of the present invention.

FIG. 14 is a circuit diagram of an antenna device 104 according to a fourth preferred embodiment of the present invention.

FIG. 15 is a circuit diagram of an antenna device 105 according to a fifth preferred embodiment of the present invention.

FIG. 16 is a plan view illustrating a relationship between shield cases SC1 and SC2 mounted on a circuit substrate, the first radiator 10, and the second radiator 20.

FIGS. 17A and 17B are plan views each illustrating a relationship between the shield cases SC1 and SC2 mounted on the circuit substrate and the first radiator 10 and the second radiator 20.

FIGS. 18A and 18B are plan views each illustrating a relationship between the shield cases SC1, SC2, and SC3 mounted on the circuit substrate and the first radiator 10 and the second radiator 20.

FIGS. 19A and 19B are diagrams each illustrating a configuration of an antenna device 111 as a first comparative example.

FIGS. 20A to 20C are diagrams each illustrating a configuration of an antenna device 112 as a second comparative example.

FIGS. 21A and 21B are diagrams each illustrating a polarity relationship between open ends of the first radiator 10 and the second radiator 20 in the antenna device 112 as a second comparative example.

### DETAILED DESCRIPTION OF THE PREFERRED EMBODIMENTS

An antenna device described in each preferred embodiment of the present invention described below may be applied to both a signal transmission side and a signal reception side. When the antenna device is described as an antenna that radiates an electromagnetic wave, the antenna device is not limited to a source that generates the electromagnetic wave. Also, in a case of receiving an electromagnetic wave radiated by a communication-partner antenna device, that is, in a case that a transmission/reception relationship is reversed, the same or substantially the same advantageous operations and effects are obtained.

### First Preferred Embodiment

An antenna device of a first preferred embodiment according to the present invention includes a circuit substrate, a first radiator, a second radiator, and a coupler, and is provided in a housing of an electronic apparatus.

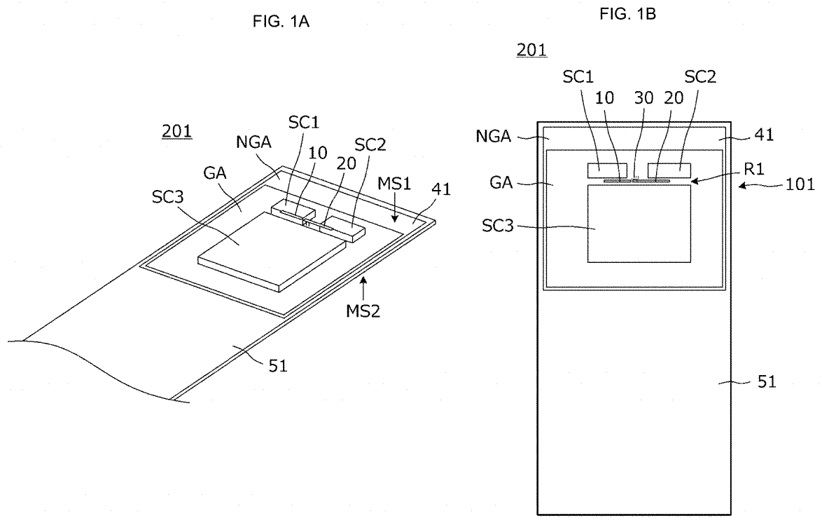

FIGS. 1A and 1B are diagrams each illustrating a main portion of an electronic apparatus 201 including an antenna device 101 according to the first preferred embodiment. FIG. 1A is a partial perspective view and FIG. 1B is a plan view. The antenna device 101 includes a circuit substrate 41 including a first main surface MS1 and a second main surface MS2 opposed to each other, a first radiator 10 including an open end, a second radiator 20 including an open end, and a coupler 30 connected to the first radiator 10 and the second radiator 20 and electromagnetically coupling the first radiator 10 and the second radiator 20, and is provided in a housing of the electronic apparatus 201.

The circuit substrate 41 includes a GND area GA being a region in which a ground conductor is provided and a GND-free area NGA being a region in which no ground conductor is provided. The circuit substrate 41 includes shield cases SC1, SC2, and SC3 as an example of mounted components. The shield cases SC1, SC2, and SC3 cover and electromagnetically shield electronic components mounted on the circuit substrate 41 and circuits provided on the circuit substrate 41. The shield cases SC1, SC2, and SC3 are disposed on the circuit substrate 41 and each include a planar conductor portion parallel or substantially parallel to the first main surface MS1.

In FIGS. 1A and 1B, a housing ground 51 is a conductor provided in the housing of the electronic apparatus and is electrically connected to a ground conductor of the circuit substrate 41.

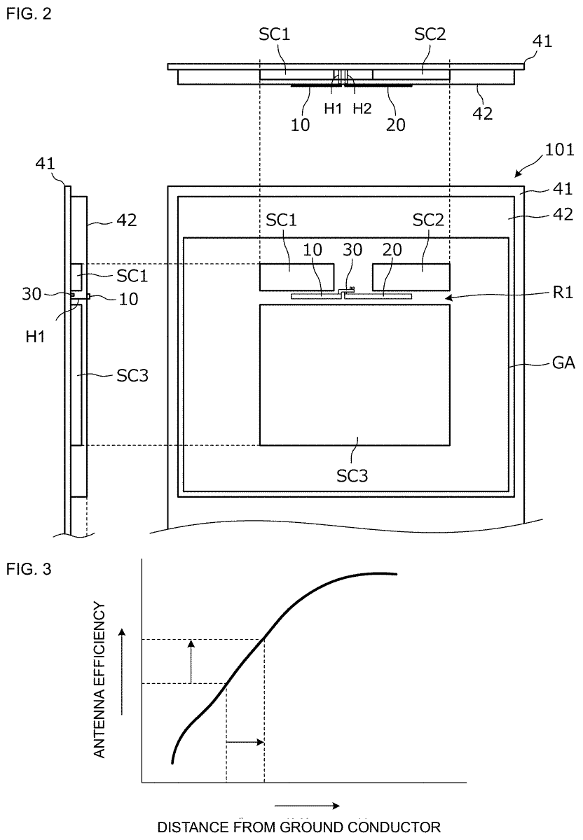

FIG. 2 is a three-view diagram of a portion corresponding to the antenna device 101. An insulation cover 42 to cover (mold) a surface of the circuit substrate 41 and the shield cases SC1, SC2, and SC3 together is provided on the surface of the circuit substrate 41. Further, the first radiator 10 and the second radiator 20 are provided on a surface of the insulation cover 42. The first radiator 10 and the second radiator 20 are directly provided on the surface of the insulation cover 42 by an LDS (Laser-Direct-Structuring) method, for example. Alternatively, a flexible substrate on which the first radiator 10 and the second radiator 20 are provided is attached to the insulation cover 42.

In FIG. 2, when a region located between the shield case SC1 and the shield case SC3 and between the shield case SC2 and the shield case SC3 in plan view of the circuit substrate 41 is expressed as a “first region R1”, the first radiator 10 overlaps the first region R1 in plan view of the circuit substrate 41. Further, in the example described above, the coupler 30 is disposed in a region located between the shield case SC1 and the shield case SC2. With this, the first radiator 10 and the second radiator 20 are separated from the shield cases SC1, SC2, and SC3 in a planar direction.

The first radiator 10 and the second radiator 20 are provided on a top surface of the insulation cover 42, and there is a predetermined space between the top surface of the insulation cover 42 and the top surfaces of the shield cases SC1, SC2, and SC3. This makes the first radiator 10 and the second radiator 20 be separated from the shield cases SC1, SC2, and SC3 also in a height direction.

A connection conductor H1 electrically connected to the first radiator 10 and a connection conductor H2 electrically connected to the second radiator 20 are provided in the insulation cover 42. The first radiator 10 and the second radiator 20 are connected to a circuit provided on the circuit substrate 41 through the connection conductors H1 and H2.

FIG. 3 is a conceptual graph illustrating a relationship between the radiation efficiency and an interval between a radiator and a ground conductor. In FIG. 3, a horizontal arrow indicates a change in an interval between the radiator and the ground conductor, and a vertical arrow indicates an increase amount in the radiation efficiency. As illustrated in the graph, the radiation efficiency increases as the radiator becomes more distant from the ground conductor, but the increase amount in the radiation efficiency gradually saturates. With this, it is important how far to separate the first radiator 10 and the second radiator 20 from the ground conductor in a short distance region. According to the present preferred embodiment, since the first radiator 10 and the second radiator 20 overlap the first region R1 located between the shield cases SC1 and SC2 and the shield case SC3 in plan view of the circuit substrate 41, the first radiator 10 and the second radiator 20 are effectively separated from the shield cases SC1, SC2, and SC3. This enables the first radiator 10 and the second radiator 20 to increase the radiation efficiency. In particular, since an open end OE1 of the first radiator 10 having a large electric potential amplitude overlaps the first region R1, the radiation efficiency of the first radiator 10 may be increased.

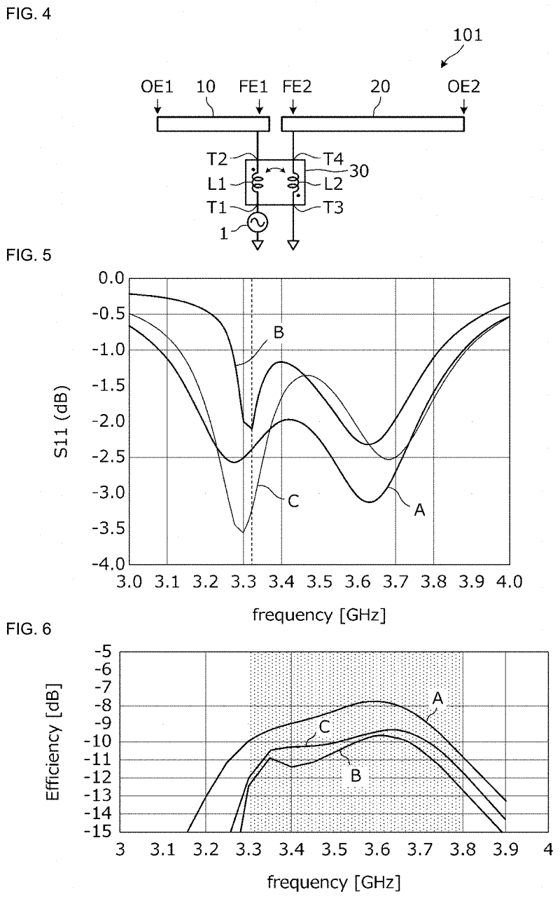

FIG. 4 is a circuit diagram of the antenna device 101. Here, the influence of the shield cases SC1, SC2, and SC3 is not expressed. In the antenna device 101, the coupler 30 includes a first coil L1 including a first end T1 and a second end T2 and a second coil L2 including a third end T3 and a fourth end T4. The first end T1 of the first coil L1 and the third end T3 of the second coil L2 are magnetically coupled in a relationship of opposite polarities in terms of magnetic field coupling.

In the example above, the first radiator 10 is a feed radiator to which a feed circuit 1 is connected through the first coil L1 of the coupler 30, and the second radiator 20 is a parasitic radiator to which the second coil L2 of the coupler 30 is connected. Both of the first radiator 10 and the second radiator 20 basically define and function as grounded quarter-wavelength monopole radiators. The line length of the first radiator 10 is shorter than the line length of the second radiator 20. That is, the first radiator 10 mainly defines and functions as a radiator in a higher frequency band, and the second radiator 20 mainly defines and functions as a radiator in a lower frequency band.

An extending direction from a feed end (connection position to the coupler 30) FE1 of the first radiator 10 to the open end OE1 of the first radiator 10 and an extending direction from a feed end (connection position to the coupler 30) FE2 of the second radiator 20 to an open end OE2 of the second radiator 20 are different from each other by about 180°.

Hereinafter, characteristics of the antenna device 101 of the present preferred embodiment and an antenna device as a comparative example thereof will be described.

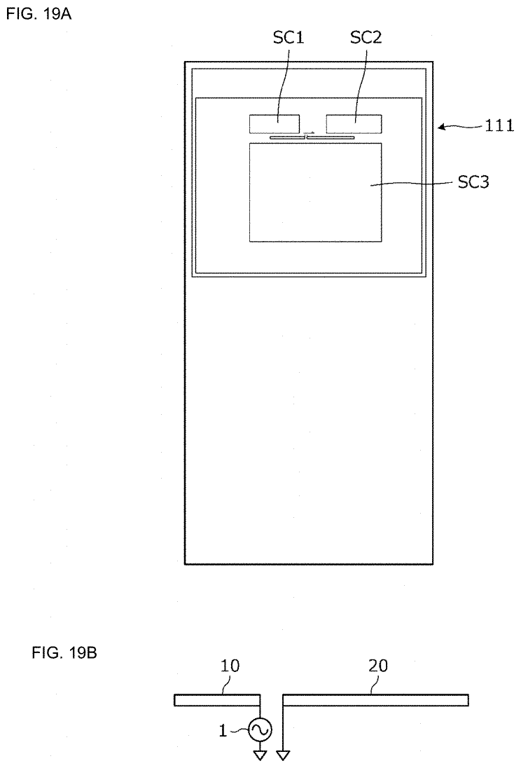

FIGS. 19A and 19B are diagrams each illustrating a configuration of an antenna device 111 as a first comparative example. FIG. 19A is a plan view of the antenna device 111, and FIG. 19B is a circuit diagram of the antenna device 111. The antenna device 111 does not include a coupler, the feed circuit 1 is directly connected to the first radiator 10, and one end of the second radiator 20 is grounded.

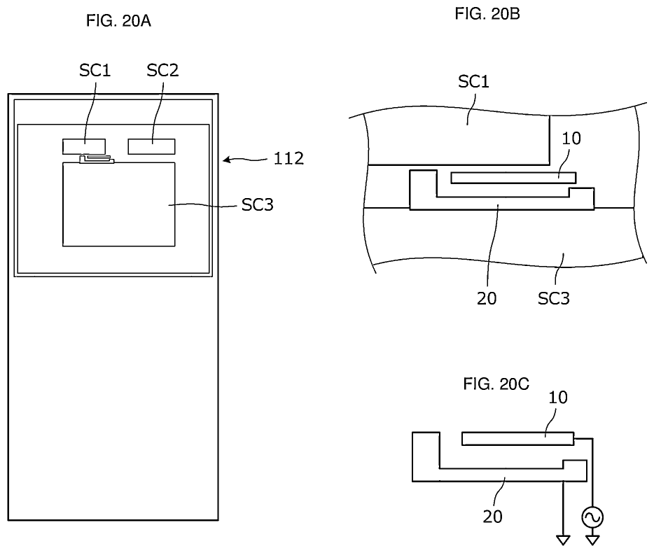

FIGS. 20A to 20C are diagrams each illustrating a configuration of an antenna device 112 as a second comparative example. FIG. 20A is a plan view of the antenna device 112, FIG. 20B is an enlarged plan view of the first radiator 10 and the second radiator 20 of the antenna device 112, and FIG. 20C is a circuit diagram of the antenna device 112. The antenna device 112 also does not include a coupler, the feed circuit 1 is directly connected to the first radiator 10, and one end of the second radiator 20 is grounded. The open end of the first radiator 10 and the open end of the second radiator 20 are close to each other. The second radiator 20 and the shield case SC3 overlap each other by about 0.2 mm in plan view, for example.

FIG. 5 is a graph illustrating a frequency characteristic of a reflection coefficient of each of the antenna devices 101, 111, and 112. In FIG. 5, a characteristic curve A indicates a characteristic of the antenna device 101, a characteristic curve B indicates a characteristic of the antenna device 111, and a characteristic curve C indicates a characteristic of the antenna device 112. In all cases, low frequency side valleys are characteristics generated by the second radiator 20 being a parasitic radiator, and a high frequency side valleys are characteristics generated by the first radiator 10 being a feed radiator.

When the antenna device 101 and the antenna device 111 are compared with each other, in the antenna device 111, the coupling between the first radiator 10 and the second radiator 20 is weak, whereas in the antenna device 101, the first radiator 10 and the second radiator 20 are coupled with a predetermined coupling coefficient through the coupler 30, so that a reflection coefficient S11 is small and preferable.

When the antenna device 101 and the antenna device 112 are compared with each other, in the antenna device 112, since the first radiator 10 and the second radiator 20 are coupled by the proximity of the open ends, a characteristic of the reflection coefficient S11 the same as or similar to that of the antenna device 101 may be obtained without a coupler.

FIG. 6 is a graph illustrating a frequency characteristic of the radiation efficiency of each of the antenna devices 101, 111, and 112. In FIG. 6, a characteristic curve A indicates a characteristic of the antenna device 101, a characteristic curve B indicates a characteristic of the antenna device 111, and a characteristic curve C indicates a characteristic of the antenna device 112.

When the antenna device 101 and the antenna device 111 are compared with each other, in the antenna device 111, the coupling between the first radiator 10 and the second radiator 20 is weak and no favorable matching may be obtained, whereas in the antenna device 101, since the first radiator 10 and the second radiator 20 are coupled with a predetermined coupling coefficient through the coupler 30, a favorable radiation efficiency may be obtained.

When the antenna device 101 and the antenna device 112 are compared with each other, also in the antenna device 112, since the first radiator 10 and the second radiator 20 are coupled by the proximity of the open ends, matching the same as or similar to that of the antenna device 101 may be obtained without a coupler. However, the first radiator 10 and the second radiator 20 need to be close to each other in order to electrically couple the first radiator 10 and the second radiator 20, and this causes a problem that the first radiator 10 and the second radiator 20 interfere with each other. Further, the antenna device 112 tends to be affected by the shield cases SC1, SC2, and SC3. Accordingly, the antenna device 101 of the present preferred embodiment may obtain a more favorable radiation efficiency characteristic.

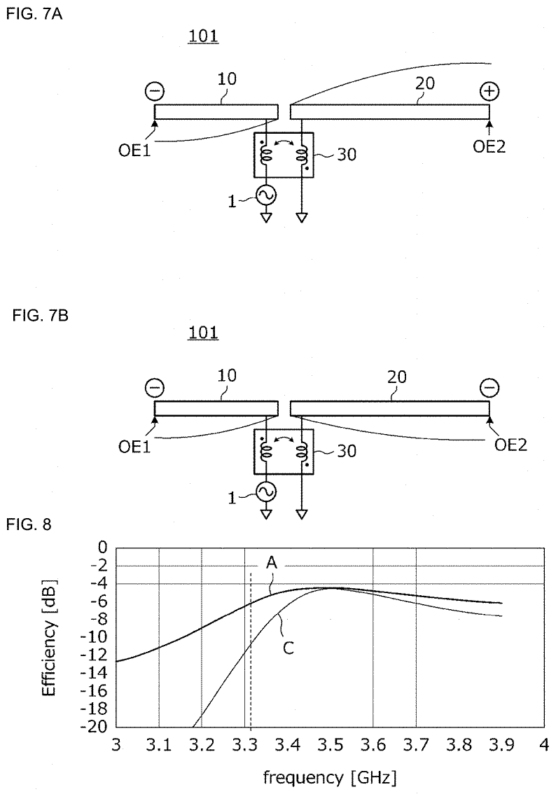

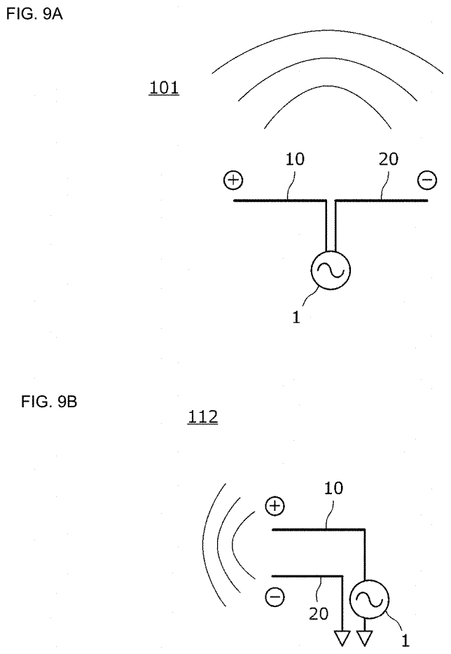

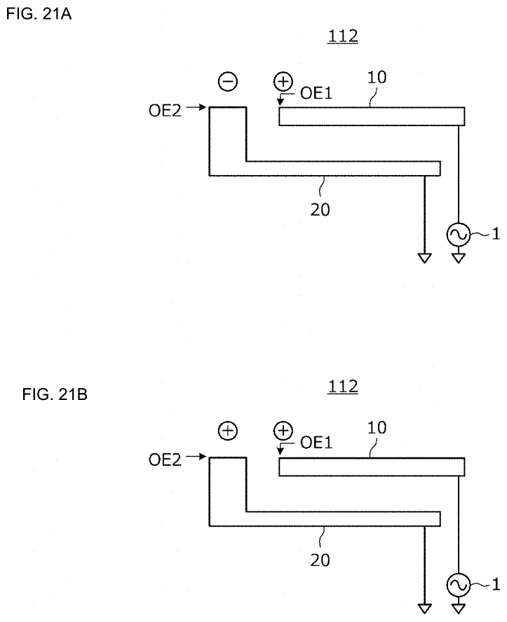

FIGS. 7A and 7B are diagrams each illustrating a polarity relationship between open ends of the first radiator 10 and the second radiator 20 in a predetermined frequency band in the antenna device 101. In FIGS. 7A and 7B, each curve along the first radiator 10 and the second radiator 20 indicates an electric potential distribution applied to the first radiator 10 and the second radiator 20. FIGS. 21A and 21B are diagrams each illustrating a polarity relationship between open ends of the first radiator 10 and the second radiator 20 in the antenna device 112 as a second comparative example. Further, FIG. 8 is a graph illustrating frequency characteristics of radiation efficiency caused by the polarity relationships described above. In FIG. 8, a frequency (for example, about 3.31 GHz) marked by a broken line indicates a resonant frequency with a parasitic element. In a frequency band lower than the frequency, the open end OE1 of the first radiator 10 and the open end OE2 of the second radiator 20 have opposite polarities as illustrated in FIG. 7A and FIG. 21A. In a frequency band higher than the frequency (for example, about 3.31 GHz) marked by the broken line, the open end OE1 of the first radiator 10 and the open end OE2 of the second radiator 20 have the same polarities as illustrated in FIG. 7B and FIG. 21B.

In FIG. 8, a characteristic curve A is a radiation efficiency (ratio of radiation power to input power) characteristic of the antenna device 101 of the present preferred embodiment, and a characteristic curve C is a radiation efficiency characteristic of the antenna device 112 as a second comparative example. In the antenna device 112, since the open end OE1 of the first radiator 10 and the open end OE2 of the second radiator 20 are close to each other, the radiation efficiency decreases in a frequency band in which the open ends of the first radiator 10 and the second radiator 20 have opposite polarities as illustrated in FIG. 21A. Whereas, in the antenna device 101 of the present preferred embodiment, since the open end OE1 of the first radiator 10 and the open end OE2 of the second radiator 20 are separated from each other, the high radiation efficiency may be maintained also in a frequency band lower than the frequency (for example, about 3.31 GHz) marked by the broken line in FIG. 8.

FIG. 9A is a diagram illustrating an operation of the antenna device 101 under a specific condition, and FIG. 9B is a diagram illustrating an operation of the antenna device 112 under a specific condition. In FIGS. 9A and 9B, multiple curves represent equiphase wavefronts. As illustrated in FIG. 9B, in the antenna device 112 as a second comparative example, an interval between an open end of the first radiator 10 and an open end of the second radiator 20 is a distance between the electric field maximum points. Since the distance is small, the radiation efficiency is small. Whereas, as illustrated in FIG. 9A, in the antenna device 101 of the present preferred embodiment, the first radiator 10 and the second radiator 20 define and function as a dipole antenna being fed power by the feed circuit 1 in a frequency band in which the open ends of the first radiator 10 and the second radiator 20 have opposite polarities. That is, since the distance between the electric field maximum points of the first radiator 10 and the second radiator 20 is large, a high radiation efficiency may be obtained.

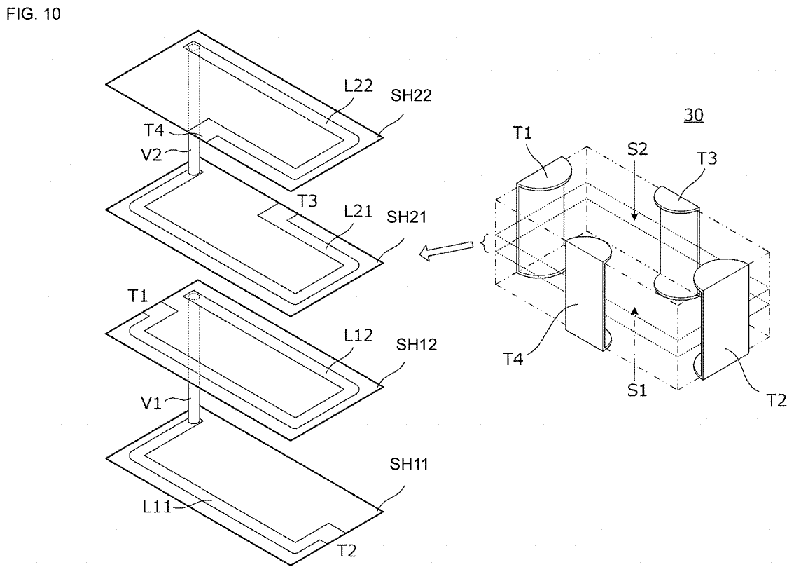

FIG. 10 is an external perspective view of the coupler 30 and an exploded perspective view thereof. The coupler 30 included in the antenna device 101 of the present preferred embodiment is a rectangular or substantially rectangular parallelepiped chip component mounted on the circuit substrate 41. In FIG. 10, an outer shape of the coupler 30 and an internal structure thereof are illustrated separately. The outer shape of the coupler 30 is indicated by a dashed-and-double-dotted line. The first end T1 of the first coil L1, the second end T2 of the first coil L1, the third end T3 of the second coil L2, and the fourth end T4 of the second coil L2 are formed on an outer surface of the coupler 30. Further, the coupler 30 has a first surface S1 and a second surface S2 which is a surface opposite to the first surface.

A first conductive pattern L11, a second conductive pattern L12, a third conductive pattern L21, and a fourth conductive pattern L22 are provided inside the coupler 30. The first conductive pattern L11 and the second conductive pattern L12 are connected to each other through the interlayer connection conductor V1. The third conductive pattern L21 and the fourth conductive pattern L22 are connected to each other through the interlayer connection conductor V2. In FIG. 10, insulation base materials SH11, SH12, SH21, and SH22 on which the respective conductive patterns are provided are separately illustrated in a lamination direction.

As illustrated in FIG. 10, the first conductive pattern L11, the second conductive pattern L12, the third conductive pattern L21, and the fourth conductive pattern L22 are provided in order from a layer closest to a mounting surface. One end of the first conductive pattern L11 is connected to the second end T2 of the first coil, and the other end is connected to one end of the second conductive pattern L12 through the interlayer connection conductor V1. The other end of the second conductive pattern L12 is connected to the first end T1 of the first coil. Further, one end of the third conductive pattern L21 is connected to the third end T3 of the second coil, and the other end of the third conductive pattern L21 is connected to one end of the fourth conductive pattern L22 through the interlayer connection conductor V2. The other end of the fourth conductive pattern L22 is connected to the fourth end T4 of the second coil.

Further, the winding direction from the first end T1 to the second end T2 of the first coil L1 is opposite to the winding direction from the third end T3 to the fourth end T4 of the second coil L2. That is, a direction of a magnetic field generated in the first coil L1 when a current flows from the first coil L1 to the first radiator 10 and a direction of a magnetic field generated in the second coil L2 when a current flows from the second coil L2 to the second radiator 20 are opposite to each other.

### Second Preferred Embodiment

In a second preferred embodiment of the present invention, there will be described a relationship between the frequency bands covered by a first radiator 10 and a second radiator 20, and a polarity of a coupler.

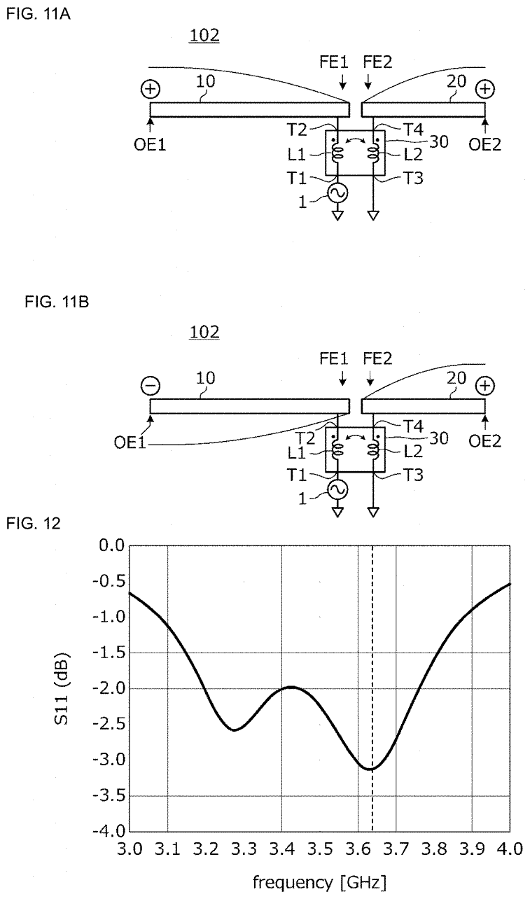

FIGS. 11A and 11B are each a circuit diagrams of an antenna device 102 according to the second preferred embodiment. The antenna device 102 according to the second preferred embodiment includes a circuit substrate, the first radiator 10, the second radiator 20, and a coupler 30 and is provided in a housing of an electronic apparatus. The configurations of the circuit substrate and the housing are as described in the first preferred embodiment.

The coupler 30 includes a first coil L1 including a first end T1 and a second end T2, and a second coil L2 including a third end T3 and a fourth end T4. The first end T1 of the first coil L1 and the third end T3 of the second coil L2 are magnetically coupled in a relationship of the same polarities.

The first radiator 10 is a feed radiator to which a feed circuit 1 is connected through the first coil L1 of the coupler 30, and the second radiator 20 is a parasitic radiator to which the second coil L2 of the coupler 30 is connected.

In FIGS. 11A and 11B, each curve along the first radiator 10 and the second radiator 20 indicates an electric potential distribution applied to the first radiator 10 and the second radiator 20 in a predetermined frequency band. Unlike the antenna device 101 of the first preferred embodiment in FIG. 4, a line length of the first radiator 10 is longer than a line length of the second radiator 20. That is, the first radiator 10 mainly acts as a radiator in a lower frequency band, and the second radiator 20 mainly acts as a radiator in a higher frequency band.

An extending direction from a feed end (connection position to the coupler 30) FE1 of the first radiator 10 to an open end OE1 of the first radiator 10 and an extending direction from a feed end (connection position to the coupler 30) FE2 of the second radiator 20 to an open end OE2 of the second radiator 20 are different from each other by about 180°.

In a frequency band lower than a predetermined frequency (about 3.31 GHz, for example), the open end OE1 of the first radiator 10 and the open end OE2 of the second radiator 20 have the same polarity as illustrated in FIG. 11A. Further, in a frequency band higher than the predetermined frequency described above, the open end OE1 of the first radiator 10 and the open end OE2 of the second radiator 20 have opposite polarities as illustrated in FIG. 11B.

FIG. 12 is a graph illustrating a frequency characteristic of a reflection coefficient of the antenna device 102. In the characteristic curve in FIG. 12, a low frequency side valley is a characteristic generated by the first radiator 10 being a feed radiator, and a high frequency side valley is a characteristic generated by the second radiator 20 being a parasitic radiator.

As illustrated in the present preferred embodiment, in a case that the first radiator 10 configured to define and function as a feed radiator is a radiator for a lower frequency band and the second radiator 20 configured to define and function as a parasitic radiator is a radiator for a higher frequency band, the coupling polarities of the first coil L1 and the second coil L2 in the coupler 30 may be set to the same or substantially the same.

The operating frequency band (lower frequency side than the broken line in FIG. 12) exhibiting a state illustrated in FIG. 11A is widened by determining the polarity in the coupler 30 as described above. Thus, unnecessary interference between the first radiator 10 and the second radiator 20 decreases, and the radiation efficiency increases.

### Third Preferred Embodiment

In a third preferred embodiment of the present invention, an antenna device including an element other than a coupler will be described.

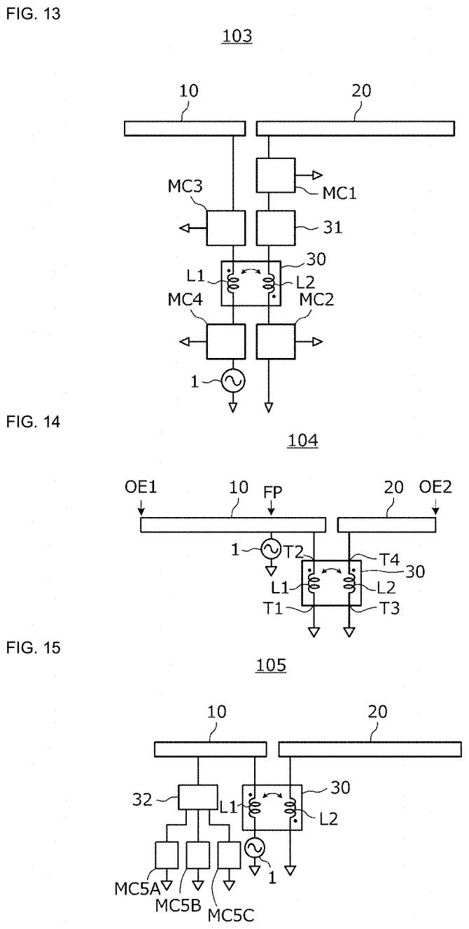

FIG. 13 is a circuit diagram of an antenna device 103 according to the third preferred embodiment. The antenna device 103 includes a phase adjusting circuit 31, a first matching circuit MC1, a second matching circuit MC2, a third matching circuit MC3, and a fourth matching circuit MC4, in addition to a first radiator 10, a second radiator 20, and a coupler 30.

The antenna device 103 includes the first matching circuit MC1 between the phase adjusting circuit 31 and the second radiator 20. The second matching circuit MC2 is provided between the second coil L2 of the coupler 30 and a ground. The third matching circuit MC3 is provided between the first coil L1 and the first radiator 10. The fourth matching circuit MC4 is provided between the first coil L1 and a feed circuit 1.

The first matching circuit MC1 is a series-connected inductor, capacitor, LC series circuit or LC parallel circuit, for example, and impedance or a resonant frequency of the second radiator 20 is appropriately determined with the configuration. Since the first matching circuit MC1 is close to the second radiator 20, the resonant frequency of the second radiator 20 may be easily determined.

The second matching circuit MC2 is a series-connected inductor, capacitor, LC series circuit or LC parallel circuit, for example, and a resonant frequency of the second radiator 20 is appropriately determined with the configuration.

The third matching circuit MC3 is a series-connected inductor or capacitor, for example, and the resonant frequency of the first radiator 10 or a degree of coupling between the first radiator 10 and the second radiator 20 is appropriately determined with the configuration.

The fourth matching circuit MC4 is a series-connected inductor, capacitor, LC series circuit or LC parallel circuit, for example. Alternatively, the fourth matching circuit MC4 is a shunt-connected inductor, capacitor, LC series circuit, or LC parallel circuit, for example. With the configurations described above, the characteristic impedance of the entire antenna device 103 is matched to the impedance of the feed circuit 1. In particular, when an interval between the first radiator 10 and a ground conductor is small, the characteristic impedance of the first radiator 10 becomes low. By configuring the fourth matching circuit MC4 to include a shunt-connected inductor, the characteristic impedance of the first radiator 10 is increased, and may be set to about 50 CI, for example.

### Fourth Preferred Embodiment

In a fourth preferred embodiment of the present invention, there will be exemplified an antenna device having a power feeding structure different from those of the examples described above.

FIG. 14 is a circuit diagram of an antenna device 104 according to the fourth preferred embodiment. The antenna device 104 includes a first radiator 10, a second radiator 20, and a coupler 30. A first end T1 of a first coil L1 of the coupler 30 is grounded and a second end T2 is connected to the vicinity of an end portion of the first radiator 10. A third end T3 of a second coil L2 of the coupler 30 is grounded and a fourth end T4 is connected to the vicinity of an end portion of the second radiator 20. The first radiator 10 includes a connection point (feed point) FP to the feed circuit 1 between a connection point to the coupler 30 and an open end OE1. That is, the first radiator 10 defines an inverted-F antenna. Since the first radiator 10 being a feed radiator is a radiator for a lower frequency band, the coupling polarities of the first coil L1 and the second coil L2 in the coupler 30 are the same or substantially the same.

As in the example described above, the antenna device may be configured to connect a feed circuit to a feed point without the coupler 30 interposed therebetween.

### Fifth Preferred Embodiment

In a fifth preferred embodiment of the present invention, an antenna device in which antenna characteristic is selectable will be described.

FIG. 15 is a circuit diagram of an antenna device 105 according to the fifth preferred embodiment. The antenna device 105 includes a first radiator 10, a second radiator 20, and a coupler 30. The antenna device 105 further includes matching circuits MC5A, MC5B, and MC5C, and a switch 32 is provided.

The switch 32 is a circuit to select which matching circuit among the multiple matching circuits MC5A, MC5B, and MC5C is used when a position separated from a feed point in the first radiator 10 is connected to a ground conductor. The matching circuits MC5A, MC5B, and MC5C are, for example, inductors or capacitors and have respective different reactance values.

According to the present preferred embodiment, the frequencies of the fundamental wave and the third harmonic wave of the first radiator 10 may be appropriately set by selecting the matching circuits MC5A, MC5B, and MC5C. This enables the size of the first radiator 10 to obtain desired antenna characteristics to be reduced, and thus, the region where the first radiator 10 is provided may be reduced.

In the example described above, matching circuits and a switch are provided to the first radiator 10 being a feed radiator, but matching circuits and a switch may be provided to the second radiator 20 being a parasitic radiator.

### Sixth Preferred Embodiment

In a sixth preferred embodiment of the present invention, there will be described an example of a first region and a second region formed with multiple shield cases. Further, some examples of an arrangement of a first radiator and a second radiator will be described.

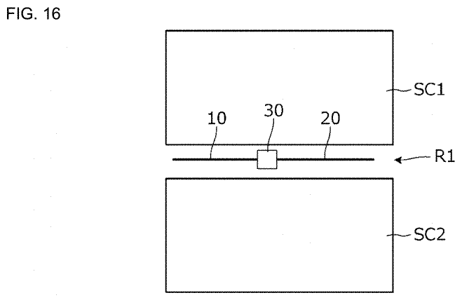

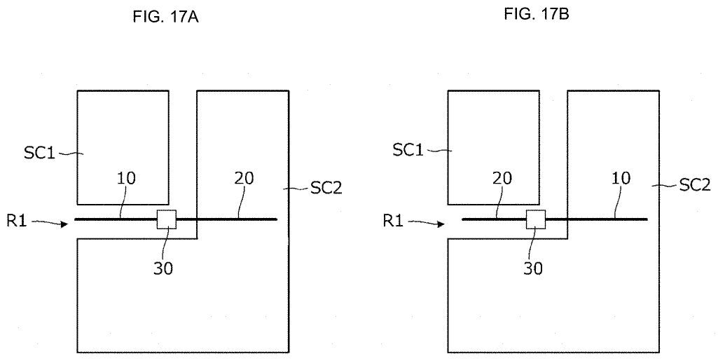

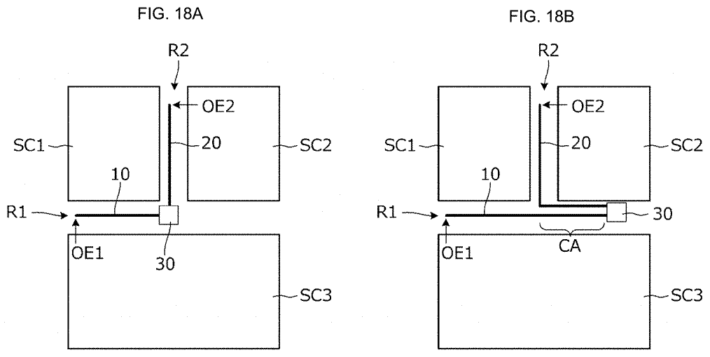

FIG. 16, FIGS. 17A and 17B, FIGS. 18A and 18B are all plan views each illustrating a relationship between shield cases mounted on a circuit substrate and a first radiator 10 and a second radiator 20. The circuit substrate is not illustrated.

In an example illustrated in FIG. 16, a linear first region R1 is provided between a shield case SC1 and a shield case SC2 in plan view of the circuit substrate. The first radiator 10 and the second radiator 20 overlap the first region R1 in plan view of the circuit substrate. With this, the first radiator 10 and the second radiator 20 are separated from the shield cases SC1 and SC2 in a planar direction.

In examples illustrated in FIGS. 17A and 17B, the first region R1 is provided between the shield case SC1 and the shield case SC2 in plan view of the circuit substrate. The first region R1 has an L-shape, for example. In the example illustrated in FIG. 17A, the first radiator 10 entirely or substantially entirely overlaps the first region R1, and the second radiator 20 partially overlaps the shield case SC2 in plan view of the circuit substrate. In the example illustrated in FIG. 17B, the second radiator 20 entirely or substantially entirely overlaps the first region R1, and the first radiator 10 partially overlaps the shield case SC2 in plan view of the circuit substrate.

As illustrated in FIGS. 17A and 17B, the first radiator 10 or the second radiator 20 may partially overlap the shield case in a planar direction. In particular, the radiation efficiency of the first radiator 10 is ensured by the first radiator 10 entirely or substantially entirely overlapping the first region R1 in plan view of the circuit substrate as illustrated in FIG. 17A, although the second radiator 20 at least partially overlaps the shield case SC2.

In examples illustrated in FIGS. 18A and 18B, the first region R1 is provided between the shield cases SC1 and SC2, and a shield case SC3 in plan view of the circuit substrate. Further, a second region R2 is provided between the shield case SC1 and the shield case SC2. The first region R1 and the second region R2 define a T-shape, for example. In the example illustrated in FIG. 18A, the first radiator 10 entirely or substantially entirely overlaps the first region R1, and the second radiator 20 entirely or substantially entirely overlaps the second region R2 in plan view of the circuit substrate. In the example illustrated in FIG. 18B, the first radiator 10 entirely or substantially entirely overlaps the first region R1 in plan view of the circuit substrate. The second radiator 20 has an L-shape, for example, and the second radiator 20 overlaps the first region R1 and the second region R2.

Since the second radiator 20 overlaps the second region R2 in plan view of the circuit substrate, the second radiator 20 is effectively separated from the shield cases SC1 and SC2, and the radiation efficiency of the second radiator 20 may also be increased. In particular, since an open end OE2 of the second radiator 20 having a large electric potential amplitude overlaps the second region R2, the radiation efficiency of the second radiator 20 may also be increased.

In the examples illustrated in FIGS. 18A and 18B, an angle is about 90 degrees which is provided by an extending direction from a connection position of the first radiator 10 to the coupler 30 to an open end OE1 of the first radiator 10 and an extending direction from a connection position of the second radiator 20 to the coupler 30 to the open end OE2 of the second radiator 20. Thus, the extending directions from the coupler 30 to the open ends of the first radiator 10 and the second radiator 20 is not necessarily about 180°. With the use of the configuration described above, a formation region of the first radiator 10 and the second radiator 20 may be reduced as a whole. The angle described above is preferably about 90° or more, for example, in order to further separate the open end OE1 of the first radiator 10 and the open end OE2 of the second radiator 20 from each other.

In the example illustrated in FIG. 18B, the first radiator 10 and the second radiator 20 extend parallel or substantially parallel to each other in a partial parallel extending portion CA. As described above, the first radiator 10 and the second radiator 20 may be partially in proximity to each other. With the use of the configuration described above, the formation region of the first radiator 10 and the second radiator 20 may be reduced. In order to reduce or prevent unnecessary coupling between the first radiator 10 and the second radiator 20, or to further separate the open end OE1 of the first radiator 10 and the open end OE2 of the second radiator 20 from each other, it is preferable that a ratio of the parallel extending portion CA to the first radiator 10 in length is, for example, about one-half or less and a ratio of the parallel extending portion CA to the second radiator 20 in length is, for example, about one-half or less.

Finally, the description of aforementioned preferred embodiments is illustrative and non-restrictive in all respects. Those skilled in the art may appropriately carry out variations and modifications. The scope of the present invention is indicated by the claims rather than the aforementioned preferred embodiments. Further, the scope of the present invention includes modifications from the preferred embodiments within the scope of the claims.

For example, in the examples described above, shield cases SC1, SC2, and SC3 mounted on a circuit substrate 41 are described as examples of mounted components according to preferred embodiments of the present invention. However, the present invention may similarly be applied to an antenna device including mounted components such as, for example, a display, an input device, and an electronic circuit component other than the shield cases SC1, SC2, and SC3.

Further, in the examples described above, a first radiator 10 and a second radiator 20 are provided on a surface of an insulation cover 42 that covers the shield cases SC1, SC2, and SC3. However, a portion or all of the first radiator 10 and the second radiator 20 may be provided on a circuit substrate.

Further, there an insulation body to insulate a portion of the first radiator 10 or the second radiator 20 from mounted components such as the shield cases SC1, SC2, and SC3 may be partially provided.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An antenna device comprising:
a circuit substrate including a first main surface and a second main surface opposed to each other, a first radiator including an open end, a second radiator including an open end, a coupler connected to the first radiator and the second radiator and electromagnetically coupling the first radiator and the second radiator, and a connection portion of a feed circuit to the first radiator; wherein
the antenna device is provided in a housing of an electronic apparatus;
multiple mounted components are provided on the circuit substrate and each include a planar conductor portion parallel or substantially parallel to the first main surface;
the first radiator, the second radiator, and the multiple mounted components are located on a side of the first main surface of the circuit substrate; and
the first radiator includes a portion overlapping a first region located between the multiple mounted components in plan view of the circuit substrate.

2. The antenna device according to claim 1, wherein
the coupler is mounted on the circuit substrate; and
each of the multiple mounted components includes a shield case covering a circuit formation portion on the circuit substrate.

3. The antenna device according to claim 1, further comprising:
an insulation cover covering the first main surface of the circuit substrate and the multiple mounted components together; wherein
the first radiator and the second radiator are provided on the insulation cover.

4. The antenna device according to claim 1, wherein the open end of the first radiator overlaps the first region.

5. The antenna device according to claim 1, wherein the second radiator includes a portion overlapping a second region located between mounted components different from mounted components of the first region among the multiple mounted components in plan view of the circuit substrate.

6. The antenna device according to claim 5, wherein the open end of the second radiator overlaps the second region.

7. The antenna device according to claim 1, wherein an extending direction of the first radiator from a connection position to the coupler to the open end of the first radiator is different from an extending direction of the second radiator from a connection position to the coupler to the open end of the second radiator.

8. The antenna device according to claim 7, wherein an angle between the extending direction of the first radiator from the connection position to the coupler to the open end of the first radiator and the extending direction of the second radiator from the connection position to the coupler to the open end of the second radiator is about 90 degrees or more.

9. The antenna device according to claim 1, wherein, in plan view, the first radiator entirely or substantially entirely overlaps the first region, and the second radiator at least partially overlaps one or more of the mounted components.

10. The antenna device according to claim 1, wherein
the first radiator and the second radiator each include a parallel extending portion where the first radiator and the second radiator extend parallel or substantially parallel to each other;
a ratio of the parallel extending portion to the first radiator in length is about one-half or less; and
a ratio of the parallel extending portion to the second radiator in length is about one-half or less.

11. The antenna device according to claim 1, further comprising an additional circuit connected between the coupler and the first radiator, between the coupler and the second radiator, or between the coupler and a ground.

12. The antenna device according to claim 1, further comprising:
multiple matching circuits connected to the first radiator or the second radiator; and
a switch to select the multiple matching circuits.

13. The antenna device according to claim 1, wherein the first radiator is an inverted-F antenna in which a connection point to the feed circuit is provided between a connection point to the coupler and the open end.

14. The antenna device according to claim 1, wherein
the coupler includes a first coil including a first end and a second end and a second coil including a third end and a fourth end, and the first end of the first coil and the third end of the second coil are magnetically coupled in opposite polarities;
the first radiator is a feed radiator to which the feed circuit is connected directly or through the first coil of the coupler;
the second radiator is a parasitic radiator to which the second coil of the coupler is connected; and
a resonant frequency of the first radiator is higher than a resonant frequency of the second radiator.

15. The antenna device according to claim 1, wherein
the coupler includes a first coil including a first end and a second end and a second coil including a third end and a fourth end, and the first end of the first coil and the third end of the second coil are magnetically coupled in a same polarities;
the first radiator is a feed radiator to which the feed circuit is connected directly or through the first coil of the coupler;
the second radiator is a parasitic radiator to which the second coil of the coupler is connected; and
a resonant frequency of the first radiator is lower than a resonant frequency of the second radiator.

16. An electronic apparatus comprising:
the antenna device according to claim 1 housed in the housing; and
a feed circuit to feed power to the antenna device directly or through the coupler.

17. The electronic apparatus according to claim 16, wherein
the coupler is mounted on the circuit substrate; and
each of the multiple mounted components includes a shield case covering a circuit formation portion on the circuit substrate.

18. The electronic apparatus according to claim 16, further comprising:
an insulation cover covering the first main surface of the circuit substrate and the multiple mounted components together;
wherein the first radiator and the second radiator are provided on the insulation cover.

19. The electronic apparatus according to claim 16, wherein the open end of the first radiator overlaps the first region.

20. The electronic apparatus according to claim 16, wherein the second radiator includes a portion overlapping a second region located between mounted components different from mounted components of the first region among the multiple mounted components in plan view of the circuit substrate.
